(19) United States
(12) Patent Application Publication
(10) Pub. No.: US 2025/0380116 A1
(43) Pub. Date: Dec. 11, 2025

(54) METHODS AND DEVICES FOR USE IN WAVEFORM SELECTION FOR SENSING AND COMMUNICATIONS

(71) Applicant: Huawei Technologies Co., Ltd., Shenzhen (CN)

(72) Inventors: Monirosharieh Vameghestahbanati, Kanata (CA); Shahram Shahsavari, Ottawa (CA); Huang Huang, Shenzhen (CN); Alireza Bayesteh, Brossard (CA)

(21) Appl. No.: 19/288,719

(22) Filed: Aug. 1, 2025

Related U.S. Application Data
(63) Continuation of application No. PCT/CN2023/074389, filed on Feb. 3, 2023.

(51) Int. Cl. H04W 4/38; H04B 1/69; H04J 13/00; H04L 27/26; H04L 41/5009; H04W 8/22

(52) U.S. Cl. CPC H04W 4/38; H04B 1/69; H04J 13/0062; H04L 27/2605; H04L 41/5009; H04W 8/22; H04B 2001/6912

(57) ABSTRACT

Some aspects of the present disclosure provide methods and devices that enable a framework for selection or configuration, or both, of a waveform for use in integrated sensing and communications (ISAC). Use of the framework provides a new waveform, based in part on various criteria, which provides a trade-off among different ISAC requirements. Therefore, when different criteria are important for a particular implementation, a waveform that best meets the requirement of those criteria may be used. The various criteria may include factors such as hardware constraints at the UE, radio frequency (RF) chirp generation or detections capability at the UE, spectral emission or leakage such as OOBE, sensing performance, and sensing complexity. In some embodiments, a cyclic prefix (CP) is provided to use the chirp-based sensing waveforms as a demodulated reference signal (DMRS). In some embodiments, the CP enables alignment with a communication signal frame.

### CROSS-REFERENCE TO RELATED APPLICATION

This application is a continuation of International Application No. PCT/CN2023/074389, entitled “METHODS AND DEVICES FOR USE IN WAVEFORM SELECTION FOR SENSING AND COMMUNICATIONS” and filed on Feb. 3, 2023, the disclosure of which is hereby incorporated by reference in its entirety.

### TECHNICAL FIELD

The present disclosure relates generally to wireless communications, and in particular to methods and devices that may be used in waveform configuration for sensing and communication.

### BACKGROUND

In some wireless communication systems, user equipment (UE) wirelessly communicates with a base station (for example, NodeB, evolved NodeB or gNB) to send data to the base station and/or receive data from the base station. A wireless communication from a UE to a base station is referred to as an uplink (UL) communication. A wireless communication from a base station to a UE is referred to as a downlink (DL) communication. A wireless communication from a first UE to a second UE is referred to as a sidelink (SL) communication or device-to-device (D2D) communication.

Resources are required to perform uplink, downlink and sidelink communications. For example, a base station may wirelessly transmit data, such as a transport block (TB), to a UE in a downlink transmission at a particular frequency and over a particular duration of time. The frequency and time duration used are examples of resources.

Sensing may be performed by a UE to obtain information about surroundings of the UE. Sensing allows the UE to detect information of one or more objects, such as, but not limited to, environment information in proximity to the UE, UE location, UE speed, UE orientation and with regard to objects in proximity to the UE, distance to an object and shape of the object. Sensing may involve the UE performing measurements of a signal that is reflected of an object. Measurements may be performed by radio frequency (RF) sensing, e.g. a radio signal reflects off of an object and is measured by the UE. There are two types of sensing, mono-static sensing and bi-static sensing. For mono-static sensing, the transmitter and the receiver are the same device. For example, the UE sends a RF signal and receives an echo to measure and determine sensing results. For bi-static sensing, the transmitter and the receiver are different devices, e.g. the base station sends sensing signals and the UE receives the echo signals, or vice versa. While sensing is described above with regard to a UE, it is also known that a base station can perform sensing. In some situations, the base station is a transmitter and the UE is a receiver or the UE is a transmitter and the base station is a receiver. In some situation, the UE or the base station can be both the transmitter and receiver.

The sixth generation (6G) of cellular systems is envisioned to transform connected people and connected things (i.e., Internet of Things (IoT)) to connected intelligence. This may be achieved by supporting a massive number of intelligent devices which have the capability of sensing their surroundings and communicating observations about their surroundings. As such, integrated sensing and communications (ISAC) is expected to be a key component in 6G systems.

It is important to satisfy requirements of both sensing and communications systems. For instance, low out-of-band emission (OOBE) is desirable for communications, while low range root-mean-square error (RMSE) and low Doppler RMSE are desirable for sensing. However, improved performance may come at the cost of higher receiver (Rx) complexity.

### SUMMARY

According to an aspect of the disclosure, there is provided a method involving: receiving, by a user equipment (UE), configuration information for configuring a sensing waveform to be used by the UE, the configuration information including an indication of whether the sensing waveform is a digital domain waveform or an analog domain waveform; and transmitting or receiving, by the UE, the sensing waveform for which the UE is configured to transmit or receive based on the configuration information.

In some embodiments, when the sensing waveform is the digital domain waveform, the sensing waveform is a Zadoff-Chu sequence.

In some embodiments, wherein when the sensing waveform is the analog domain waveform, the sensing waveform is one of: a frequency modulated continuous wave waveform (FMCW); a non-symmetric triangular chirp waveform; or a symmetric triangular chirp waveform.

In some embodiments, the method further involves transmitting, by the UE, capability information of the UE, pertaining to at least one of transmitting or receiving of communication signaling and sensing signaling between the UE and a network serving the UE.

In some embodiments, the capability information includes information pertaining to at least one of: hardware constraints of the UE; receiver complexity of the UE; an analog-to-digital convertor (ADC) sampling rate (SR) supported by the UE; transmitter processing capability of the UE; receiver processing capability of the UE; radio frequency (RF) domain chirp generation capability of the UE; RF domain chirp detection capability of the UE; and key performance indicators (KPIs) of the UE pertaining to sensing by the UE.

In some embodiments, the configuration information is further based upon at least one or more of: an out of band emission (OOBE) requirement; a range root-mean-square error (RMSE) requirement; a doppler RMSE requirement; and a number of sensing symbols to be processed in a fixed period of sensing time. The sensing symbol may be regarded as the smallest unit of time over which a sensing waveform can be defined.

In some embodiments, the UE is at least one of a transmitter of the sensing waveform or a receiver of the sensing waveform.

In some embodiments, the sensing waveform is used for demodulation reference signal (DMRS).

In some embodiments, the sensing waveform includes a cyclic prefix (CP), wherein the CP is used to align the sensing waveform with an orthogonal frequency division multiplexing (OFDM) frame.

In some embodiments, aligning the sensing waveform with OFDM frame includes adding the CP so that a total sensing waveform time duration is equal to an OFDM frame time duration.

In some embodiments, 1) a starting frequency of the sensing waveform and CP is f_{L} or f_{H}, where f_{L} is a lowest frequency of the bandwidth of the sensing waveform and f_{H} is a highest frequency of the bandwidth of the sensing waveform, and after varying between the f_{H} or f_{L}, respectively, and back to f_{L} or f_{H}, respectively, ending at a frequency equal to f_{L}+Rₛ_{₁}n_{CPs}_{₁} or f_{H}−Rₛ_{₁}n_{CPs}_{₁}, respectively, where n_{CPs}_{ᵢ} is the CP length and Rₛ_{ᵢ} the sampling rate of the ith sensing symbol; or 2) a starting frequency of the CP is as f_{L}+Rₛ_{₁}n_{CPs}_{₁} or f_{H}−Rₛ_{₁}n_{CPs}_{₁}, and after varying between the f_{L} or f_{H}, respectively, and to f_{H} or f_{L}, respectively, ending at a frequency equal to the f_{L} or f_{H}, respectively. In some embodiments, different starting frequencies may be mapped to different UEs.

According to some aspects of the disclosure there is provided a device including a processor and a computer-readable storage media. The computer-readable storage media has stored thereon, computer executable instructions, that when executed by the processor, perform a method as described above or detailed below.

According to an aspect of the disclosure, there is provided a method involving: transmitting, by a transmit receive point (TRP), configuration information for configuring a sensing waveform to be used by the UE, the configuration information including an indication of whether the sensing waveform is a digital domain waveform or an analog domain waveform; and transmitting or receiving, by the TRP, a sensing waveform the UE is configured to receive or transmit based on the configuration information.

In some embodiments, when the sensing waveform is the digital domain waveform, the sensing waveform is a Zadoff-Chu sequence.

In some embodiments, when the sensing waveform is the analog domain waveform, the sensing waveform is one of: a FMCW; a non-symmetric triangular chirp waveform; or a symmetric triangular chirp waveform.

In some embodiments, the method further involves receiving, by the TRP, capability information of the UE, pertaining to at least one of transmission or receiving of communication signaling and sensing signaling between the UE and a network serving the UE.

In some embodiments, the method further involves determining, by the TRP, whether the sensing waveform is a digital domain waveform or an analog domain waveform based at least in part on the capability information.

In some embodiments, the capability information includes information pertaining to at least one of: hardware constraints of the UE; receiver complexity of the UE; an ADC SR supported by the UE; transmitter processing capability of the UE; receiver processing capability of the UE; RF domain chirp generation capability of the UE, RF domain chirp detection capability of the UE; and KPIs pertaining to sensing by the UE.

In some embodiments, the configuration information is further based upon at least one or more of: an OOBE requirement; a range RMSE requirement; and a doppler RMSE requirement. In some embodiments, the configuration information may be based on a number of symbols to be processed in a fixed period of sensing time.

In some embodiments, the method further involves converting, by the TRP, KPIs pertaining to sensing by the UE into parameters used in determining the sensing waveform.

In some embodiments, the method further involves comparing, by the TRP, the ADC SR supported by the UE to a bandwidth of the sensing waveform and when the supported SR is greater than the bandwidth of the sensing waveform, determining the sensing waveform is a Zadoff-Chu sequence.

In some embodiments, the method further involves comparing, by the TRP, the ADC SR supported by the UE to a bandwidth of the sensing waveform and when the supported SR is less than the bandwidth of the sensing waveform and the UE does not have RF chirp generation capability or RF chirp detection capability, or both, but the UE can perform sensing based on the UE capabilities, determining the sensing waveform is a Zadoff-Chu sequence.

In some embodiments, the method further involves comparing, by the TRP, the ADC SR supported by the UE to a bandwidth of the sensing waveform and when the supported SR is less than the bandwidth of the sensing waveform, the UE has RF chirp generation capability or RF chirp detection capability, or both, OOBE is a constraint, sensing performance is a constraint, but sensing complexity is not a constraint, determining the sensing waveform is a non-symmetric triangular chip waveform or a symmetric triangular chip waveform.

In some embodiments, the method further involves comparing, by the TRP, the ADC SR supported by the UE to a bandwidth of the sensing waveform and: 1) when the supported SR is less than the bandwidth of the sensing waveform, the UE has RF chirp generation capability or RF chirp detection capability, or both, and OOBE is not a constraint; or 2) when the supported SR is less than the bandwidth of the sensing waveform, the UE has RF chirp generation capability or RF chirp detection capability, or both, OOBE is not a constraint, and sensing performance is not a constraint; or 3) when the supported SR is less than the bandwidth of the sensing waveform, the UE has RF chirp generation capability or RF chirp detection capability, or both, OOBE is not a constraint, sensing performance is not a constraint, and sensing complexity is a constraint; and determining the waveform is a FMCW waveform.

In some embodiments, the sensing waveform is determined based on the relationship

$${x}^{( {p}_{i} )} ( t , {l}^{′} ) = {x}_{{α}_{1 , {l}^{′}}} ( t - {l}^{′} {T}_{s} ) Π ( \frac{t - {l}^{′} {T}_{s}}{{β}_{l ′} {T}_{s}} ) + ( 1 - {ϑ}^{( {p}_{i} )} ) {e}^{j 2 π ( {β}_{{l}^{′}} {α}_{1 , {l}^{′}} {T}_{s} ) t} {x}_{- {α}_{2 , {l}^{′}}} ( t - ( {l}^{′} + {β}_{{l}^{′}} ) {T}_{s} ) Π ( \frac{t - ( {l}^{′} + {β}_{{l}^{′}} ) {T}_{s}}{( 1 - {β}_{l ′} ) {T}_{s}} ) ,$$

wherein: pᵢ is an ith antenna port, where i is an integer; l′ is a sensing symbol index; Nₛ a number of sensing symbols in a sensing waveform resource; ϑ^{(p}^{ᵢ}⁾=1 and β_{l′}=1 for the FMCW waveform; ϑ^{(p}^{ᵢ}⁾=0 and

$${β}_{l ′} = \frac{B}{{α}_{1 , {l}^{′}} T}$$

for a triangular waveform; B is sensing waveform bandwidth; Tₛ sensing symbol time duration; α_{1,l′} and α_{2,l′} are chirp rates; and

$$Π ( \frac{t}{{T}_{s}} ) = \{ \begin{matrix}1 & 0 \leq t \leq {T}_{s} \\ 0 & otherwise\end{matrix} .$$

In some embodiments, the sensing waveform is used for demodulation reference signal (DMRS).

In some embodiments, the sensing waveform includes a CP, and wherein the CP is used to align the sensing waveform with an OFDM frame.

In some embodiments, aligning the sensing waveform with OFDM frame includes adding the CP so that a total sensing waveform time duration is equal to an OFDM frame time duration.

In some embodiments, 1) a starting frequency of the sensing waveform and CP is f_{L} or f_{H}, where f_{L} is a lowest frequency of the bandwidth of the sensing waveform and f_{H} is a highest frequency of the bandwidth of the sensing waveform, and after varying between the f_{H} or f_{L}, respectively, and back to f_{L} or f_{H}, respectively, ending at a frequency equal to f_{L}+Rₛ_{₁}n_{CPs}_{₁} or f_{H}−Rₛ_{₁}n_{CPs}_{₁}, respectively, where n_{CPs}_{ᵢ} is the CP length and Rₛthe rate of the ith sensing symbol; or 2) a starting frequency of the CP is as f_{L} +Rₛ_{₁}n_{CPs}_{₁} or f_{H}−Rₛ_{₁}n_{CPs}_{₁}, and after varying between the f_{L} or f_{H}, respectively, and to f_{H} or f_{L}, respectively, ending at a frequency equal to the f_{L} or f_{H}, respectively. In some embodiments, different starting frequencies may be mapped to different UEs.

According to some aspects of the disclosure there is provided a device including a processor and a computer-readable storage media. The computer-readable storage media has stored thereon, computer executable instructions, that when executed by the processor, perform a method as described above or detailed below.

According to an aspect of the disclosure, there is provided a method involving: determining, by a UE, configuration information for configuring a sensing waveform to be used by the UE for sensing, the configuration information for indicating whether the sensing waveform is a digital domain waveform or an analog domain waveform, the configuration information based at least in part on capability information pertaining to at least one of transmission or receiving of communication signaling and sensing signaling between the UE and a network serving the UE; transmitting or receiving, by the UE, a waveform for which the UE is configured to receive or transmit using the configuration information.

In some embodiments, the method further involves transmitting, by the UE, capability information pertaining to at least one of transmission or receiving of communication signaling and sensing signaling between the UE and a network serving the UE.

In some embodiments, the method further involves receiving, by the UE, configuration information from the TRP that the UE is to use instead of the configuration information for configuring a waveform determined by the UE.

In some embodiments, when the sensing waveform is the digital domain waveform, the sensing waveform is a Zadoff-Chu sequence.

In some embodiments, when the sensing waveform is the analog domain waveform, the sensing waveform is one of: a FMCW; a non-symmetric triangular chirp waveform; or a symmetric triangular chirp waveform.

In some embodiments, the capability information includes information pertaining to at least one of: hardware constraints of the UE; receiver complexity of the UE; an ADC SR supported by the UE; transmitter processing capability of the UE; receiver processing capability of the UE; RF domain chirp generation capability of the UE; RF domain chirp detection capability of the UE; and KPIs of the UE pertaining to sensing by the UE.

In some embodiments, the configuration information is further based upon at least one or more of: an OOBE requirement; a range RMSE requirement; and a doppler RMSE requirement. In some embodiments, the configuration information may be based on a number of symbols to be processed in a fixed period of sensing time.

In some embodiments, the UE is at least one of a transmitter of the sensing waveform or a receiver of the sensing waveform.

In some embodiments, the method further involves determining, by the UE, the sensing waveform.

In some embodiments, the method further involves converting, by the UE, KPIs of the UE pertaining to sensing by the UE into parameters used in determining the sensing waveform.

In some embodiments, the method further involves comparing, by the UE, the ADC SR supported by the UE to a bandwidth of the sensing waveform and when the supported SR is greater than the bandwidth of the sensing waveform, determining the sensing waveform is a Zadoff-Chu sequence.

In some embodiments, the method further involves comparing, by the UE, the ADC SR supported by the UE to a bandwidth of the sensing waveform and when the supported SR is less than the bandwidth of the sensing waveform and the UE does not have RF chirp generation capability or RF chirp detection capability, or both, but the UE can perform sensing based on the UE capabilities, determining the sensing waveform is a Zadoff-Chu sequence.

In some embodiments, the method further involves comparing, by the UE, the ADC SR supported by the UE to a bandwidth of the sensing waveform and when the supported SR is less than the bandwidth of the sensing waveform, the UE has RF chirp generation capability or RF chirp detection capability, or both, OOBE is a constraint, sensing performance is a constraint, but sensing complexity is not a constraint, determining the sensing waveform is a non-symmetric triangular chip waveform or a symmetric triangular chip waveform.

In some embodiments, the method further involves comparing, by the UE, the ADC SR supported by the UE to a bandwidth of the sensing waveform and: 1) when the supported SR is less than the bandwidth of the sensing waveform, the UE has RF chirp generation capability or RF chirp detection capability, or both, and OOBE is not a constraint; or 2) when the supported SR is less than the bandwidth of the sensing waveform, the UE has RF chirp generation capability or RF chirp detection capability, or both, OOBE is not a constraint, and sensing performance is not a constraint; or 3) when the supported SR is less than the bandwidth of the sensing waveform, the UE has RF chirp generation capability or RF chirp detection capability, or both, OOBE is not a constraint, sensing performance is not a constraint, and sensing complexity is a constraint; and determining the waveform is a FMCW waveform.

In some embodiments, the waveform to be used for ISAC is determined based on the relationship

$${x}^{( {p}_{i} )} ( t , {l}^{′} ) = {x}_{{α}_{1 , {l}^{′}}} ( t - {l}^{′} {T}_{s} ) Π ( \frac{t - {l}^{′} {T}_{s}}{{β}_{l ′} {T}_{s}} ) + ( 1 - {ϑ}^{( {p}_{i} )} ) {e}^{j 2 π ( {β}_{{l}^{′}} {α}_{1 , {l}^{′}} {T}_{s} ) t} {x}_{- {α}_{2 , {l}^{′}}} ( t - ( {l}^{′} + {β}_{{l}^{′}} ) {T}_{s} ) Π ( \frac{t - ( {l}^{′} + {β}_{{l}^{′}} ) {T}_{s}}{( 1 - {β}_{l ′} ) {T}_{s}} ) ,$$

wherein: pᵢ is an ith antenna port, where i is an integer; l′ is a sensing symbol index; Nₛ a number of sensing symbols in a sensing waveform resource; ϑ^{(p}^{ᵢ}⁾=1 and β_{l ′}=1 for the FMCW waveform; ϑ^{(p}^{ᵢ}⁾=0 and

$${β}_{l ′} = \frac{B}{{α}_{1 , {l}^{′}} T}$$

for a triangular waveform; B is sensing waveform bandwidth; Tₛ sensing symbol time duration; α_{1,l′} and α_{2,l′} are chirp rates; and

$$Π ( \frac{t}{{T}_{s}} ) = \{ \begin{matrix}1 & 0 \leq t \leq {T}_{s} \\ 0 & otherwise\end{matrix} .$$

In some embodiments, the waveform is used for demodulation reference signal (DMRS).

In some embodiments, the waveform includes a CP, and wherein the CP is used to align the sensing waveform with an OFDM frame.

In some embodiments, aligning the sensing waveform with OFDM frame includes adding the CP so that a total sensing waveform time duration is equal to an OFDM frame time duration.

In some embodiments, 1) a starting frequency of the sensing waveform and CP is f_{L} or f_{H}, where f_{L} is a lowest frequency of the bandwidth of the sensing waveform and f_{H} is a highest frequency of the bandwidth of the sensing waveform, and after varying between the f_{H} or f_{L}, respectively, and back to f_{L} or f_{H}, respectively, ending at a frequency equal to f_{L}+Rₛ_{₁}n_{CPs}_{₁} or f_{H}−Rₛ_{₁}n_{CPs}_{₁}, respectively, where n_{CPs}_{ᵢ} is the CP length and Rₛ; the rate of the ith sensing symbol; or 2) a starting frequency of the CP is as f_{L} +Rₛ_{₁}n_{CPs}_{₁} or f_{H}−Rₛ_{₁}n_{CPs}_{₁}, and after varying between the f_{L} or f_{H}, respectively, and to f_{H} or f_{L}, respectively, ending at a frequency equal to the f_{L} or f_{H}, respectively. In some embodiments, different starting frequencies may be mapped to different UEs.

According to some aspects of the disclosure there is provided a device including a processor and a computer-readable storage media. The computer-readable storage media has stored thereon, computer executable instructions, that when executed by the processor, perform a method as described above or detailed below.

According to an aspect of the disclosure, there is provided a method involving: receiving, by a TRP, configuration information from a user equipment that is determined by the UE, the configuration information for configuring a sensing waveform to be used by the UE, the configuration information based at least in part on capability information pertaining to at least one of transmission or receiving of communication signaling and sensing signaling between the UE and a network serving the UE; and transmitting or receiving, by the TRP, a waveform for which the UE is configured to transmit or receive using the configuration information.

In some embodiments, the method further involves receiving, by the TRP, the capability information.

In some embodiments, the method further involves determining, by the TRP, configuration information for the UE to use instead of the configuration information determined by the UE for configuring a waveform to be used by the UE.

In some embodiments, the method further involves transmitting, by the TRP, the configuration information to the UE that the UE is to use instead of the configuration information determined by the UE.

In some embodiments, when the sensing waveform is the digital domain waveform, the sensing waveform is a Zadoff-Chu sequence.

In some embodiments, when the sensing waveform is the analog domain waveform, the sensing waveform is one of: a FMCW; a non-symmetric triangular chirp waveform; or a symmetric triangular chirp waveform.

In some embodiments, the capability information includes information pertaining to at least one of: hardware constraints of the UE; receiver complexity of the UE; an ADC SR supported by the UE; transmitter processing capability of the UE; receiver processing capability of the UE; RF domain chirp generation capability of the UE; RF domain chirp detection capability of the UE; and KPIs of the UE pertaining to sensing by the UE.

In some embodiments, the configuration information is further based upon at least one or more of: an OOBE requirement; a range RMSE requirement; a doppler RMSE requirement; and a number of symbols to be processed in a fixed period of sensing time.

In some embodiments, the waveform is used for demodulation reference signal (DMRS).

In some embodiments, the waveform includes a CP, and wherein the CP is used to align the sensing waveform with an OFDM frame.

In some embodiments, aligning the sensing waveform with OFDM frame includes adding the CP so that a total sensing waveform time duration is equal to an OFDM frame time duration.

In some embodiments, 1) a starting frequency of the sensing waveform and CP is f_{L} or f_{H}, where f_{L} is a lowest frequency of the bandwidth of the sensing waveform and f_{H} is a highest frequency of the bandwidth of the sensing waveform, and after varying between the f_{H} or f_{L}, respectively, and back to f_{L} or f_{H}, respectively, ending at a frequency equal to f_{L}+Rₛ_{₁}n_{CPs}_{₁} or f_{H}−Rₛ_{₁}n_{CPs}_{₁}, respectively, where n_{CPs}; is the CP length and Rₛ; the rate of the ith sensing symbol; or 2) a starting frequency of the CP is as f_{L}+Rₛ_{₁}n_{CPs}_{₁} or f_{H}−Rₛ_{₁}n_{CPs}_{₁}, and after varying between the f_{L} or f_{H}, respectively, and to f_{H} or f_{L}, respectively, ending at a frequency equal to the f_{L} or f_{H}, respectively. In some embodiments, different starting frequencies may be mapped to different UEs.

According to some aspects of the disclosure there is provided a device including a processor and a computer-readable storage media. The computer-readable storage media has stored thereon, computer executable instructions, that when executed by the processor, perform a method as described above or detailed below.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1A is a schematic diagram of a communication system in which embodiments of the present disclosure may occur.

FIG. 1B is another schematic diagram of a communication system in which embodiments of the present disclosure may occur.

FIG. 2 is a block diagram illustrating units or modules in a device in which embodiments of the present disclosure may occur.

FIG. 3 is a block diagram illustrating units or modules in a device in which embodiments of the present disclosure may occur.

FIG. 4A is a graphical plot showing a time and frequency relationship of a frequency modulated continuous wave (FMCW) waveform.

FIG. 4B is a graphical plot showing a time and frequency relationship of a symmetric triangular chirp waveform.

FIG. 5 is a graphical plot showing a comparison of out-of-band emission (OOBE) performance of different types of waveforms for a particular set of parameter values.

FIG. 6A is a graphical plot showing a comparison of range root-mean-square error for a range of signal-to-noise ratios (SNR) for a FMCW waveform and a symmetric triangular chirp waveform for different numbers of symbols.

FIG. 6B is a graphical plot showing a comparison of Doppler root-mean-square error for a range of SNR for a FMCW waveform and a symmetric triangular chirp waveform for different numbers of symbols.

FIG. 7 is a table providing a comparison of waveform attributes for three waveform types including a Zadoff-Chu (ZC) sequence, FMCW waveform, and a symmetric triangular chirp waveform.

FIG. 8 is a schematic diagram illustrating frequency-multiplexing of sensing with communication signaling according to as aspect of the present disclosure.

FIG. 9 illustrates an example flow chart for selection of a waveform type for a waveform selection framework in accordance with embodiments of the present disclosure.

FIG. 10A illustrates an example of a signal flow diagram for uplink (UL) signaling between a transmit receive point (TRP) and a UE in accordance with embodiments of the present disclosure.

FIG. 10B illustrates an example of a signal flow diagram for downlink (DL) signaling between a TRP and a UE in accordance with embodiments of the present disclosure.

FIG. 11A illustrates an example of a cyclic prefix (CP) generation for a symmetric triangular chirp in accordance with embodiments of the present disclosure.

FIG. 11B illustrates another example of a cyclic prefix (CP) generation for a symmetric triangular chirp in accordance with embodiments of the present disclosure.

### DETAILED DESCRIPTION

For illustrative purposes, specific example embodiments will now be explained in greater detail below in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, apparatus or device disclosed herein that executes instructions may include or otherwise have access to a non-HWC transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e. DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

According to some aspects of the present disclosure, there is provided a framework that enables selection or configuration, or both, of a waveform for use in integrated sensing and communications (ISAC). Use of the framework provides a new waveform, based in part on various criteria, which provides a trade-off among different ISAC requirements. Therefore, when different criteria are important for a particular implementation, a waveform that best meets the requirement of those criteria may be used. The various criteria may include factors such as hardware constraints at the UE, radio frequency (RF) chirp generation or detections capability at the UE, spectral emission or leakage such as OOBE, sensing performance, and receiver complexity in ISAC.

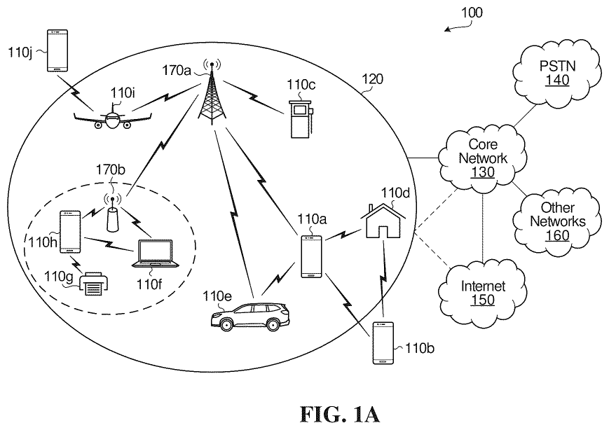

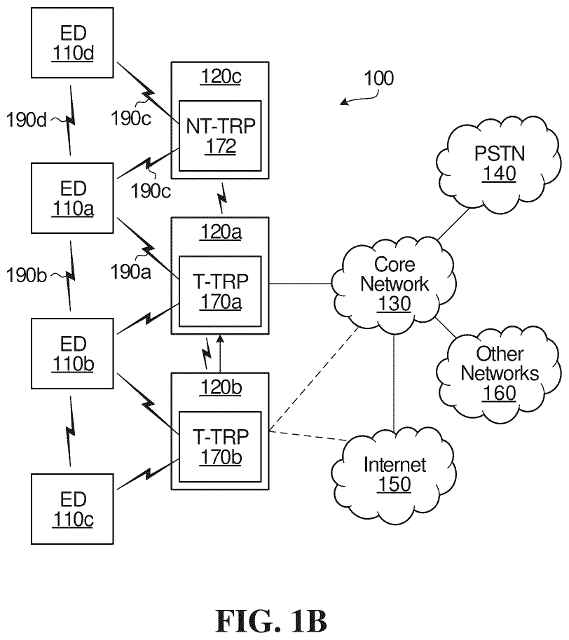

FIGS. 1A, 1B, and 2 following below provide context for the network and device that may be in the network and that may implement aspects of the present disclosure.

Referring to FIG. 1A, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another, and may also or instead be connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

FIG. 1B illustrates an example communication system 100 in which embodiments of the present disclosure could be implemented. In general, the system 100 enables multiple wireless or wired elements to communicate data and other content. The purpose of the system 100 may be to provide content (voice, data, video, text) via broadcast, narrowcast, user device to user device, etc. The system 100 may operate efficiently by sharing resources such as bandwidth.

In this example, the communication system 100 includes electronic devices (ED) 110a-110c, radio access networks (RANs) 120a-120b, a core network 130, a public switched telephone network (PSTN) 140, the Internet 150, and other networks 160. While certain numbers of these components or elements are shown in FIG. 1B, any reasonable number of these components or elements may be included in the system 100.

The EDs 110a-110c are configured to operate, communicate, or both, in the system 100. For example, the EDs 110a-110c are configured to transmit, receive, or both via wireless communication channels. Each ED 110a-110c represents any suitable end user device for wireless operation and may include such devices (or may be referred to) as a user equipment/device (UE), wireless transmit/receive unit (WTRU), mobile station, mobile subscriber unit, cellular telephone, station (STA), machine type communication device (MTC), personal digital assistant (PDA), smartphone, laptop, computer, touchpad, wireless sensor, or consumer electronics device.

FIG. 1B illustrates an example communication system 100 in which embodiments of the present disclosure could be implemented. In general, the communication system 100 enables multiple wireless or wired elements to communicate data and other content. The purpose of the communication system 100 may be to provide content (voice, data, video, text) via broadcast, multicast, unicast, user device to user device, etc. The communication system 100 may operate by sharing resources such as bandwidth.

In this example, the communication system 100 includes electronic devices (ED) 110a-110d, radio access networks (RANs) 120a-120c, a core network 130, a public switched telephone network (PSTN) 140, the internet 150, and other networks 160. Although certain numbers of these components or elements are shown in FIG. 1B, any reasonable number of these components or elements may be included in the communication system 100.

The EDs 110a-110d are configured to operate, communicate, or both, in the communication system 100. The EDs can also be referred to as a terminal device. For example, the EDs 110a-110d are configured to transmit, receive, or both, via wireless or wired communication channels. Each ED 110a-110d represents any suitable end user device for wireless operation and may include such devices (or may be referred to) as a user equipment/device (UE), wireless transmit/receive unit (WTRU), mobile station, fixed or mobile subscriber unit, cellular telephone, station (STA), machine type communication (MTC) device, personal digital assistant (PDA), smartphone, laptop, computer, tablet, wireless sensor, or consumer electronics device.

In FIG. 1B, the RANs 120a-120b include base stations 170a-170b, respectively. Each base station 170a-170b is configured to wirelessly interface with one or more of the EDs 110a-110c to enable access to any other base station 170a-170b, the core network 130, the PSTN 140, the internet 150, and/or the other networks 160. For example, the base stations 170a-170b may include (or be) one or more of several well-known devices, such as a base transceiver station (BTS), a Node-B (NodeB), an evolved NodeB (eNodeB), a Home eNodeB, a gNodeB, a transmission and receive point (TRP), a site controller, an access point (AP), or a wireless router. The base stations, the core network and other components relate to the network can also be referred as network device.

In some examples, one or more of the base stations 170a-170b may be a terrestrial base station that is attached to the ground. For example, a terrestrial base station could be mounted on a building or tower. Alternatively, one or more of the base stations 172 may be a non-terrestrial base station, or non-terrestrial TRP (NT-TRP), that is not attached to the ground. A flying base station is an example of the non-terrestrial base station. A flying base station may be implemented using communication equipment supported or carried by a flying device. Non-limiting examples of flying devices include airborne platforms (such as a blimp or an airship, for example), balloons, quadcopters and other aerial vehicles. In some implementations, a flying base station may be supported or carried by an unmanned aerial system (UAS) or an unmanned aerial vehicle (UAV), such as a drone or a quadcopter. A flying base station may be a moveable or mobile base station that can be flexibly deployed in different locations to meet network demand. A satellite base station is another example of a non-terrestrial base station. A satellite base station may be implemented using communication equipment supported or carried by a satellite. A satellite base station may also be referred to as an orbiting base station.

Any ED 110a-110d may be alternatively or additionally configured to interface, access, or communicate with any other base station 170a-170b, the internet 150, the core network 130, the PSTN 140, the other networks 160, or any combination of the preceding.

The EDs 110a-110d and base stations 170a-170b, 172 are examples of communication equipment that can be configured to implement some or all of the operations and/or embodiments described herein. In the embodiment shown in FIG. 1B, the base station 170a forms part of the RAN 120a, which may include other base stations, base station controller(s) (BSC), radio network controller(s) (RNC), relay nodes, elements, and/or devices. Any base station 170a, 170b may be a single element, as shown, or multiple elements, distributed in the corresponding RAN, or otherwise. Also, the base station 170b forms part of the RAN 120b, which may include other base stations, elements, and/or devices. Each base station 170a-170b transmits and/or receives wireless signals within a particular geographic region or area, sometimes referred to as a “cell” or “coverage area”. A cell may be further divided into cell sectors, and a base station 170a-170b may, for example, employ multiple transceivers to provide service to multiple sectors. In some embodiments, there may be established pico or femto cells where the radio access technology supports such. In some embodiments, multiple transceivers could be used for each cell, for example using multiple-input multiple-output (MIMO) technology. The number of RAN 120a-120b shown is exemplary only. Any number of RAN may be contemplated when devising the communication system 100.

The base stations 170a-170b, 172 communicate with one or more of the EDs 110a-110c over one or more air interfaces 190a, 190c using wireless communication links e.g. radio frequency (RF), microwave, infrared (IR), etc. The air interfaces 190a, 190c may utilize any suitable radio access technology. For example, the communication system 100 may implement one or more orthogonal or non-orthogonal channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a, 190c.

A base station 170a-170b, 172 may implement Universal Mobile Telecommunication System (UMTS) Terrestrial Radio Access (UTRA) to establish an air interface 190a, 190c using wideband CDMA (WCDMA). In doing so, the base station 170a-170b. 172 may implement protocols such as High Speed Packet Access (HSPA), Evolved HPSA (HSPA+) optionally including High Speed Downlink Packet Access (HSDPA), High Speed Packet Uplink Access (HSPUA) or both. Alternatively, a base station 170a-170b, 172 may establish an air interface 190a, 190c with Evolved UTMS Terrestrial Radio Access (E-UTRA) using LTE, LTE-A, and/or LTE-B. It is contemplated that the communication system 100 may use multiple channel access operation, including such schemes as described above. Other radio technologies for implementing air interfaces include IEEE 802.11, 802.15, 802.16, CDMA2000, CDMA2000 1X, CDMA2000 EV-DO, IS-2000, IS-95, IS-856, GSM, EDGE, and GERAN. Of course, other multiple access schemes and wireless protocols may be utilized.

The RANs 120a-120b are in communication with the core network 130 to provide the EDs 110a-110c with various services such as voice, data, and other services. The RANs 120a-120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a-120b or EDs 110a-110c or both, and (ii) other networks (such as the PSTN 140, the internet 150, and the other networks 160).

The EDs 110a-110d communicate with one another over one or more sidelink (SL) air interfaces 190b, 190d using wireless communication links e.g. radio frequency (RF), microwave, infrared (IR), etc. The SL air interfaces 190b, 190d may utilize any suitable radio access technology, and may be substantially similar to the air interfaces 190a, 190c over which the EDs 110a-110c communication with one or more of the base stations 170a-170b, or they may be substantially different. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the SL air interfaces 190b, 190d. In some embodiments, the SL air interfaces 180 may be, at least in part, implemented over unlicensed spectrum.

In addition, some or all of the EDs 110a-110d may include operation for communicating with different wireless networks over different wireless links using different wireless technologies and/or protocols. Instead of wireless communication (or in addition thereto), the EDs may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as internet protocol (IP), transmission control protocol (TCP) and user datagram protocol (UDP). EDs 110a-110d may be multimode devices capable of operation according to multiple radio access technologies, and incorporate multiple transceivers necessary to support multiple radio access technologies.

In some embodiments, the signal is transmitted from a terrestrial BS to the UE or transmitted from the UE directly to the terrestrial BS and in both cases the signal is not reflected by a RIS. However, the signal may be reflected by the obstacles and reflectors such as buildings, walls and furniture. In some embodiments, the signal is communicated between the UE and a non-terrestrial BS such as a satellite, a drone and a high altitude platform. In some embodiments, the signal is communicated between a relay and a UE or a relay and a BS or between two relays. In some embodiments, the signal is transmitted between two UEs. In some embodiments, one or multiple RIS are utilized to reflect the signal from a transmitter and a receiver, where any of the transmitter and receiver includes UEs, terrestrial or non-terrestrial BS, and relays.

FIG. 2 illustrates another example of an ED 110 and network devices, including a base station 170a, 170b (at 170) and an NT-TRP 172. The ED 110 is used to objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 2, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIGS. 1A or 1B). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 210 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distributed unit (DU), positioning node, among other possibilities. The T-TRP 170 may be macro BSs, pico BSs, relay node, donor node, or the like, or combinations thereof. The T-TRP 170 may refer to the forging devices, or to apparatus (e.g. communication module, modem, or chip) in the forgoing devices. While the figures and accompanying description of example and embodiments of the disclosure generally use the terms AP, BS, and AP or BS, it is to be understood that such device could be any of the types described above.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. multiple-input multiple-output (MIMO) precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

One or more steps of the embodiment methods provided herein may be performed by corresponding units or modules, according to FIG. 2. FIG. 2 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

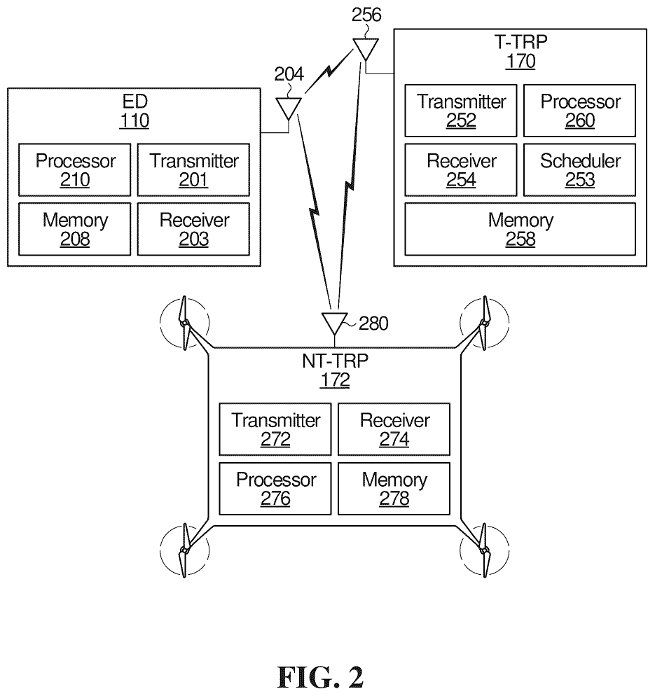

One or more steps of the embodiment methods provided herein may be performed by corresponding units or modules, according to FIG. 3. FIG. 3 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

Further terrestrial and non-terrestrial networks can enable a new range of services and applications such as earth monitoring, remote sensing, passive sensing and positioning, navigation, and tracking, autonomous delivery and mobility. Terrestrial networks based sensing and non-terrestrial networks based sensing could provide intelligent context-aware networks to enhance the UE experience. For example, terrestrial networks based sensing and non-terrestrial networks based sensing may involve opportunities for localization and sensing applications based on a new set of features and service capabilities. Applications such as THz imaging and spectroscopy have the potential to provide continuous, real-time physiological information via dynamic, non-invasive, contactless measurements for future digital health technologies. Simultaneous localization and mapping (SLAM) methods will not only enable advanced cross reality (XR) applications but also enhance the navigation of autonomous objects such as vehicles and drones. Further in terrestrial and non-terrestrial networks, the measured channel data and sensing and positioning data can be obtained by the large bandwidth, new spectrum, dense network and more light-of-sight (LOS) links. Based on these data, a radio environmental map can be drawn through AI/ML methods, where channel information is linked to its corresponding positioning or environmental information to provide an enhanced physical layer design based on this map.

Sensing coordinators are nodes in a network that can assist in the sensing operation. These nodes can be standalone nodes dedicated to just sensing operations or other nodes (for example TRP 170, ED 110, or core network node) doing the sensing operations in parallel with communication transmissions. A new protocol and signaling mechanism is needed so that the corresponding interface link can be performed with customized parameters to meet particular requirements while minimizing signaling overhead and maximizing the whole system spectrum efficiency.

AI/ML and sensing methods are data-hungry. In order to involve AI/ML and sensing in wireless communications, more and more data are needed to be collected, stored, and exchanged. The characteristics of wireless data expand quite large ranges in multiple dimensions, e.g., from sub-6 GHz, millimeter to Terahertz carrier frequency, from space, outdoor to indoor scenario, and from text, voice to video. These data collecting, processing and usage operations are performed in a unified framework or a different framework.

Control information is referenced in some embodiments herein. Control information may sometimes instead be referred to as control signaling, or signaling. In some cases, control information may be dynamically communicated, e.g. in the physical layer in a control channel, such as in a physical uplink control channel (PUCCH) or physical uplink shared channel (PUSCH) or physical downlink control channel (PDCCH). An example of control information that is dynamically indicated is information sent in physical layer control signaling, e.g. uplink control information (UCI) sent in a PUCCH or PUSCH or downlink control information (DCI) sent in a PDCCH. A dynamic indication may be an indication in a lower layer, e.g. physical layer/layer 1 signaling, rather than in a higher-layer (e.g. rather than in radio resource control (RRC) signaling or in a MAC CE). A semi-static indication may be an indication in semi-static signaling. Semi-static signaling, as used herein, may refer to signaling that is not dynamic, e.g. higher-layer signaling (such as RRC signaling), and/or a MAC CE. Dynamic signaling, as used herein, may refer to signaling that is dynamic, e.g. physical layer control signaling sent in the physical layer, such as DCI sent in a PDCCH or UCI sent in a PUCCH or PUSCH.

A sensing system may be used to help gather pose information for a particular object, such as an apparatus. Pose information may include, for example, one or more of: a relative location of the particular object (e.g. with respect to a reference point or other apparatus), location in a global coordinate system, movement of the object (relative or in a global coordinate system), orientation information and the information about the wireless environment. “Location” is also known as “position” and these two terms may be used interchangeably herein. The relative location of the object may include a distance to the object or a direction to the object, or both. The movement of the object may include a speed, direction of movement and/or acceleration of the object, for example.

Sensing systems may be particularly useful for obtaining pose information for electronic devices, which may be referred to as ED pose information. ED pose information may be used in cellular communication networks to improve various performance metrics for the network. Such performance metrics may, for example, include capacity, agility and/or efficiency. The improvement may be achieved when elements of the network exploit the position, the behavior, the mobility pattern, etc. of the ED in the context of a priori information describing a wireless environment in which the ED is operating.

Examples of well-known sensing systems include RADAR (Radio Detection and Ranging) and LIDAR (Light Detection and Ranging). While the sensing system is typically separate from the communication system, it could be advantageous to gather the information using an integrated system to reduce the hardware (and cost) in the system as well as the time, frequency or spatial resources needed to perform both functionalities. However, using the communication system hardware to perform sensing of ED pose and environment information is a highly challenging problem. The difficulty of the problem relates to factors such as the limited resolution of the communication system, the dynamic nature of the environment, and the huge number of objects whose electromagnetic properties and position are to be estimated.

Accordingly, integrated sensing and communication (also known as integrated communication and sensing) is a desirable feature in existing and future communication systems.

Any or all of the EDs 110 and TRPs 170 in FIGS. 1A, 1B, 2 and 3 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications and are, instead, dedicated to sensing. For example, the system 100 may further include a dedicated sensing agent, which is an example of a sensing node that is dedicated to sensing. Unlike the EDs 110 and TRPs 170, the dedicated sensing agent does not transmit or receive communication signals. However, the dedicated sensing agent may communicate configuration information, sensing information, signaling information, or other information within the communication system 100. In some cases, a plurality of dedicated sensing agents may be implemented and may communicate with each other to jointly perform a sensing task. The dedicated sensing agent may be in communication with the core network 130 to communicate information with the rest of the communication system 100. By way of example, referring again to FIG. 1B, the dedicated sensing agent may determine the location of the ED 110a, and transmit this information to the base station 170a via the core network 130. Although no dedicated sensing agent is shown in FIG. 1B, any number of sensing agents may be implemented in the communication system 100. In some embodiments, one or more dedicated sensing agents may be implemented at one or more of the RANs 120.

A sensing node may combine sensing-based techniques with reference signal-based techniques to enhance UE pose determination. Reference signal-based techniques may be considered as a type of bi-static (or multi-static) sensing, particularly when measurements of reference signals are used for pose estimation. This type of sensing node may also be known as a node that implements a sensing management function (SMF). In some networks, the SMF may also be known as a node that implements a location management function (LMF). The SMF may be implemented as a physically independent entity located at the core network 130 with connection to the multiple TRPs 170. In other aspects of the present application, the SMF may be implemented as a logical entity co-located inside a TRP, such as the T-TRP 170, through logic carried out by a processor in the TRP, such as the processor 260 in FIG. 2.

In one example, an SMF may be implemented as a physically independent entity that includes at least one processor, at least one transmitter, at least one receiver, one or more antennas and at least one memory. A transceiver may be used instead of the transmitter and the receiver. A scheduler may be coupled to the processor of the SMF. The scheduler may be included within or operated separately from the SMF. The processor implements various processing operations of the SMF, such as signal coding, data processing, power control, input/output processing or any other functionality. The processor can also be configured to implement some or all of the functionality and/or embodiments described in more detail above. The processor includes any suitable processing or computing device configured to perform one or more operations. The processor could, for example, include a microprocessor, microcontroller, digital signal processor, field programmable gate array or application specific integrated circuit.

A reference signal-based pose determination technique belongs to an “active” pose estimation paradigm. In an active pose estimation paradigm, the enquirer of pose information (e.g. the electronic device 110) takes part in process of determining the pose of the enquirer. The enquirer may transmit or receive and process (or both transmit and receive/process) a signal that is specific to the pose determination process. Positioning techniques based on a global navigation satellite system (GNSS) such as the known Global Positioning System (GPS) are other examples of the active pose estimation paradigm. Various positioning technologies are also known in NR systems and in LTE systems.

In contrast, a sensing technique, based on radar and/or lidar for example, may be considered as belonging to a “passive” pose determination paradigm. In a passive pose determination paradigm, the target may be oblivious to the pose determination process.

By integrating sensing and communications in one system, the system need not operate according to only a single paradigm. Thus, the combination of sensing-based techniques and reference signal-based techniques can yield enhanced pose determination.

The enhanced pose determination may, for example, include obtaining ED channel sub-space information, which is particularly useful for ED channel reconstruction at the sensing node, especially for a beam-based operation and communication. The ED channel sub-space is a subset of the entire algebraic space, defined over the spatial domain, in which the entire channel from the TP to the ED lies. Accordingly, the ED channel sub-space defines the TRP-to-ED channel with very high accuracy. The signals transmitted over other sub-spaces result in a negligible contribution to the ED channel. Knowledge of the ED channel sub-space helps to reduce the effort needed for channel measurement at the ED and channel reconstruction at the network-side. Therefore, the combination of sensing-based techniques and reference signal-based techniques may enable the ED channel reconstruction with much less overhead as compared to traditional methods. Sub-space information can also facilitate sub-space-based sensing to reduce sensing complexity and improve sensing accuracy.

In some embodiments of integrated sensing and communication, a same radio access technology (RAT) is used for sensing and communication. This avoids the need to multiplex two different RATs under one carrier spectrum, or necessitating two different carrier spectrums for the two different RATs.

In embodiments that integrate sensing and communication under one RAT, a first set of channels may be used to transmit a sensing signal and a second set of channels may be used to transmit a communications signal. In some embodiments, each channel in the first set of channels and each channel in the second set of channels is a logical channel, a transport channel or a physical channel.

At the physical layer, communication and sensing may be performed via separate physical channels. For example, a first physical downlink shared channel PDSCH-C is defined for data communication, while a second physical downlink shared channel PDSCH-S is defined for sensing. Similarly, separate physical uplink shared channels (PUSCH), PUSCH-C and PUSCH-S, could be defined for uplink communication and sensing.

In another example, the same channels (e.g. the same PDSCH and PUSCH) could be used for both communication and sensing. Separate logical layer channels and/or transport layer channels may be defined for communication and sensing. Note also that control channel(s) and data channel(s) for sensing can have the same or different channel structure (format), occupy same or different frequency bands or bandwidth parts.

In a further example, a common physical downlink control channel (PDCCH) and a common physical uplink control channel (PUCCH) may be used to carry control information for both sensing and communication. Alternatively, separate physical layer control channels may be used to carry separate control information for communication and sensing. For example, PUCCH-S and PUCCH-C could be used for uplink control for sensing and communication respectively and PDCCH-S and PDCCH-C for downlink control for sensing and communication respectively.

Different combinations of shared and dedicated channels for sensing and communication, at each of the physical, transport, and logical layers, are possible.

The term RADAR originates from the phrase Radio Detection and Ranging; however, expressions with different forms of capitalization (e.g. Radar and radar) are equally valid and now more common. Radar is typically used for detecting a presence and a location of an object. A radar system radiates radio frequency energy and receives echoes of the energy reflected from one or more targets. The system determines the pose of a given target based on the echoes (also referred to as reflections) returned from the given target. The radiated energy can be in the form of an energy pulse or a continuous wave, which can be expressed or defined by a particular waveform. Examples of waveforms used in radar include frequency modulated continuous wave (FMCW) and ultra-wideband (UWB) waveforms.

Radar systems can be monostatic, bi-static or multi-static. In a monostatic radar system, the radar signal transmitter and receiver are co-located, such as being integrated in a transceiver. In a bi-static radar system, the transmitter and receiver are spatially separated. The distance of separation is typically comparable to, or larger than, the expected target distance (often referred to as the range). In a multi-static radar system, two or more radar components are spatially diverse but with a shared area of coverage. A multi-static radar is also referred to as a multisite or netted radar.

Terrestrial radar applications encounter challenges such as multipath propagation and shadowing impairments. Another challenge is the problem of identifiability because terrestrial targets have similar physical attributes. Integrating sensing into a communication system is likely to suffer from these same challenges, and more.

Communication nodes may be either half-duplex or full-duplex. A half-duplex node cannot both transmit and receive using the same physical resources (time, frequency, etc.); conversely, a full-duplex node may transmit and receive using the same physical resources. Existing commercial wireless communications networks are all half-duplex. Even if full-duplex communications networks become practical in the future, it is expected that at least some of the nodes in the network will still be half-duplex nodes because half-duplex devices are less complex, and have lower cost and lower power consumption. In particular, full-duplex implementation is more challenging at higher frequencies (e.g. in millimeter wave bands) and very challenging for small and low-cost devices, such as femtocell base stations and UEs.

The limitation of half-duplex nodes in the communications network presents further challenges toward integrating sensing and communications into the devices and systems of the communications network. For example, both half-duplex and full-duplex nodes can perform bi-static or multi-static sensing, but monostatic sensing typically requires the sensing node have full-duplex capability. A half-duplex node may perform monostatic sensing with certain limitations, such as in a pulsed radar with a specific duty cycle and ranging capability.

Properties of a sensing signal, or a signal used for both sensing and communication, include the waveform of the signal and the frame structure of the signal. The frame structure defines the time-domain boundaries of the signal. The waveform describes the shape of the signal as a function of time and frequency.

It is envisioned that the majority of nodes in future wireless networks will be capable of performing sensing. However, wireless networks have limited network resources. Techniques for effectively and efficiently sharing the wireless channel between multiple nodes are needed to prevent sensing performance from being limited by the availability of wireless resources.

Techniques for sharing a wireless channel between multiple sensing nodes may be referred to as sensing multiple access. Sensing multiple access seeks enable to sensing services for multiple sensing nodes using the limited time-frequency resources in a shared medium (the wireless channel). An effective sensing multiple access technique should seek to minimize interference between different sensing nodes. Interference may occur when, for example, sensing nodes that are close to one another transmit on the same time-frequency resources.

One approach to sharing a wireless channel between multiple sensing nodes is to schedule different sensing nodes in separate time-frequency resources to reduce the risk of interference when the nodes perform sensing. However, this may result in significant demand for time-frequency resources to enable sensing across a network, which may be detrimental to the performance of other services, such as communication.

Another approach is to provide sensing nodes with orthogonal or semi-orthogonal sensing waveforms so that a receiver of a sensing signal may differentiate between different sensing signals using post-processing e.g. using a correlator.

A combination of these two approaches may be adopted. For example, the 5^{th} Generation (5G) New Radio (NR) standard defines OFDM-modulated Zadoff-Chu sequences for Uplink Sounding Reference Signals (UL-SRS). UL-SRS may be used in communication networks for tasks such as channel sounding, uplink transmission of timing control, and reciprocity-based multi-user downlink precoding. For multiple access in 5G NR networks, different apparatus (e.g. different user equipments) may be assigned different time-frequency resources and/or different parameters of a Zadoff-Chu sequence.

As another example, downlink positioning reference signals (DL-PRS) in 5G NR networks may be based on a Gold sequence, such that different apparatus (e.g. different TRPs) may be multiplexed in the time-frequency domain as well as according to the parameters of the Gold sequence.

In 5G NR networks, the waveforms of UL-SRS and DL-PRS are defined in the digital baseband domain in the form of sequences. Although such digitally defined signals provide flexibility in multiple access, processing sequences at the receiver side may be complex and power consuming due to the need for digital baseband processing to achieve acceptable performance.

While 5G NR standard defines digital sequences for communication, Radar, which is an example of sensing, has typically used linear frequency modulated signal-based waveforms, which are expressed in the radio frequency (RF) analog domain. A linear frequency modulated signal (LFM) has a frequency that is a linear function of time. An LFM may also be referred to as a chirp. The slope of an LFM may be referred to as the rate, or chirp rate, of the LFM.

One element of ISAC systems that plays a role in fulfilling both sensing and communications requirements is selection of waveforms that are to be used. There currently exist several different waveforms for ISAC, each with pros and cons. Different types of waveforms, such as analog domain waveforms that include a frequency modulated continuous wave (FMCW) waveform, and a symmetric triangular chirp waveform and a digital domain waveform that includes a Zadoff-Chu (ZC) sequence, will now be described.

FMCW, which may be considered as a collection of chirps, is a possible waveform candidate for sensing due to its simplicity and sensing performance. In a scenario in which Tₛ denotes a sensing symbol duration, B denotes the bandwidth, f₀ denotes the carrier frequency, and θ₀ denotes the initial phase, the FMCW waveform may be expressed as:

$$x ( t ) = {e}^{- j ( π α {t}^{2} + 2 π {f}_{0} t + {θ}_{0} )} , \qquad ( 1 )$$

where

$$α = \frac{B}{{T}_{s}}$$

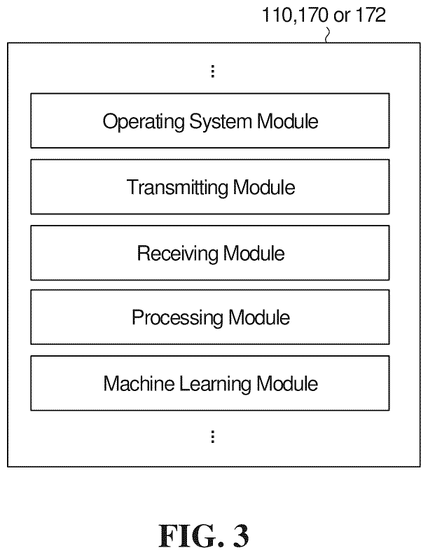

represents a chip rate, and t∈[0, Tₛ]. The frequency of each chirp is expressed as:

$$f = \frac{d φ ( t )}{d t} = - 2 π ( α t + {f}_{0} ) , \qquad ( 2 )$$

where φ(t) denotes a phase of x(t). The frequency of the FMCW waveform is a linear function of time. FIG. 4A illustrates a graphical example of a FMCW waveform 400. The horizontal axis represents time and the vertical axis represents frequency. The duration between o and Tₛ is representative of a sensing symbol duration and there are two durations of Tₛ shown in FIG. 4A. The value fₒ represents an initial frequency value, and the value of fₒ−B denotes a change in frequency equal to the bandwidth B. The change in frequency is a linear change over each symbol duration having a negative slope equal to α=B/Tₛ.

The ZC sequence is a sampled version of FMCW waveform. The ZC sequence is used in Long Term Evolution (LTE) and New Radio (NR). The ZC sequence may be expressed in the form:

$${x}_{q} ( m ) = {e}^{- j \frac{π q m ( m + 1 )}{{N}_{z c}}} , \qquad ( 3 )$$

where q is a root of the ZC sequence and N_{zc} is a length of the ZC sequence, and m∈[0, N_{zc}).

The symmetric triangular chirp waveform may be expressed as shown in equation (4) below:

$$x ( t ) = \{ \begin{matrix}{e}^{j ( - πα {t}^{2} + 2 π {f}_{0} t + {θ}_{0} )} & t ∈ [ 0 , {T}_{s} / 2 ] \\ {e}^{j ( + πα {t}^{2} + 2 π {f}_{0} t + {θ}_{0} )} & t ∈ [ \frac{{T}_{s}}{2} , {T}_{s} ]\end{matrix} . \qquad ( 4 )$$

The symmetrical triangular chirp waveform comprises two chirps with opposite sign slopes, e.g., downchirp in the first symbol duration and upchirp in the second duration, or vice versa. FIG. 4B depicts the time-frequency relationship of an example symmetric triangular chirp waveform 450. The horizontal axis represents time and the vertical axis represents frequency. The duration between o and Tₛ is representative of a sensing symbol time duration shown in FIG. 4B. The value fo represents an initial frequency value and the value of fo−B denotes a change in frequency equal to the bandwidth B. The change in frequency is a linear change over the duration o to Tₛ/2 having a negative slope of −α=−B/(Tₛ/2) and a linear change over the duration Tₛ/2 to Tₛ having a positive slope of α=B/(Tₛ/2).

As mentioned above, to provide good performance in an ISAC system, it is important to satisfy requirements of both sensing and communications systems. For instance, low out-of-band emission (OOBE) is desirable for communications, while low range root-mean-square error (RMSE) and low Doppler RMSE are desirable for sensing. In some situations, the higher the number of symbols given a fixed sensing time, the better the performance. However, processing a higher number of symbols in a fixed time may come at the cost of higher receiver complexity.

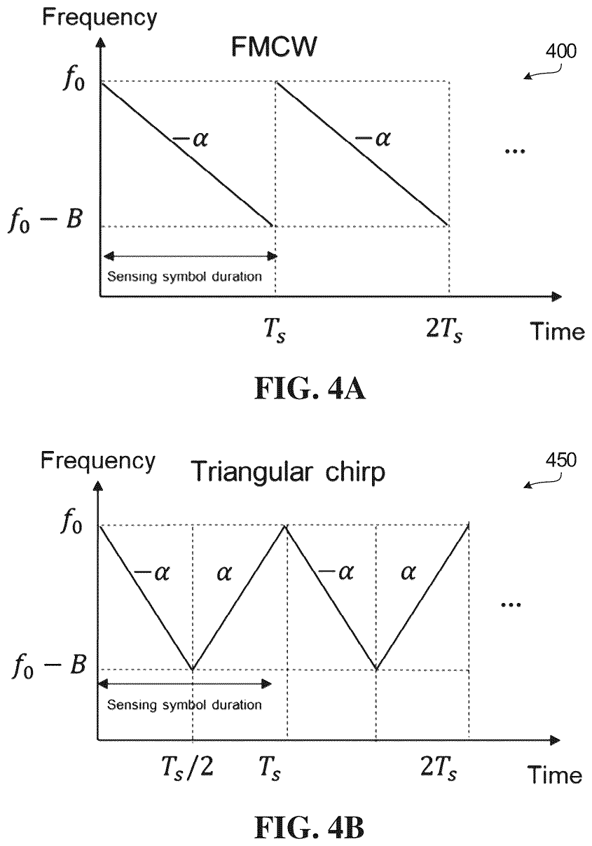

FIG. 5 is a graphical plot 500 that illustrates a comparison between OOBE performance of a NR ZC sequence with a cyclic prefix orthogonal frequency divisional multiplexing (CP-OFDM) waveform without windowing, a NR ZC sequence with the CP-OFDM waveform with weighted-overlap-and-add (WOLA) windowing, a FMCW waveform with no windowing, and a symmetric triangular chirp waveform with no windowing. The parameters for all four types of waveforms include a subcarrier spacing (SCS) of 60 KHz, bandwidth of 25 MHz, and 14 symbols. Also included in the graphical plot is a 3rd Generation Partnership Project (3GPP) spectral emission mask (SEM) as a reference waveform. The horizontal axis of the graphical plot 500 is representative of frequency and the vertical axis of the graphical plot 500 is representative of power spectral density (PSD). FIG. 5 shows that the NR ZC with WOLA windowing provides improved OOBE performance over the NR ZC without windowing waveform. FIG. 5 illustrates that the symmetric triangular chirp without windowing waveform achieves a similar OOBE performance as the ZC sequence waveform with WOLA windowing. FIG. 5 also illustrates that the FMCW waveform has the worst OOBE performance. This is because the FMCW waveform is discontinuous at the boundaries of different symbols, while the symmetrical triangular chirp waveform is considered to be continuous. It should be noted that WOLA cannot be used in conjunction with FMCW, because the FMCW waveform is an analog waveform.

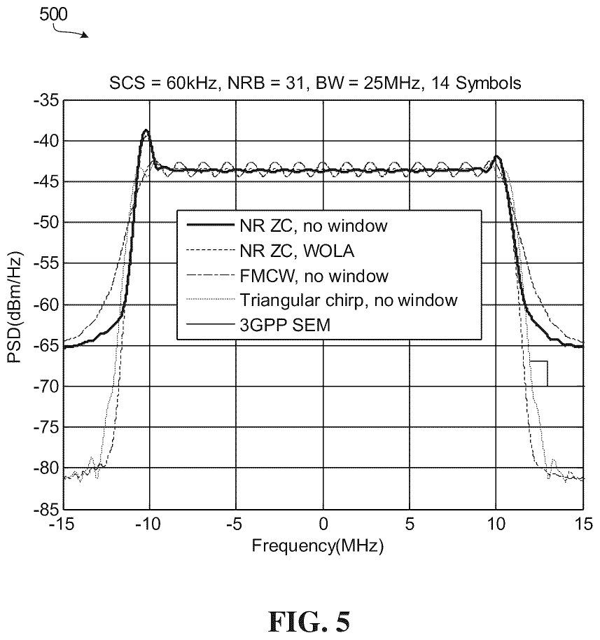

FIG. 6A and FIG. 6B are example graphical plots 600, 650 used to compare FMCW waveforms and the symmetric triangular chirp waveforms with different numbers of symbols in a fixed sensing time for range RMSE and for Doppler RMSE. In FIG. 6A, the horizontal axis of the graphical plot 600 is representative of a range of signal-to-noise ratio (SNR) and the vertical axis of the graphical plot 600 is representative of a range of range RMSE. In FIG. 6B, the horizontal axis of the graphical plot 650 is representative of a range of SNR and the vertical axis of the graphical plot 650 is representative of a range of Doppler RMSE. FIGS. 6A and 6B illustrate that, for each of the waveform types, the higher a number of processed symbols, the better the performance. For example, in FIG. 6A, a waveform for 8 symbols in a fixed sensing time range has a smaller range RMSE than a waveform with 2 symbols in a fixed sensing time range for a given SNR and a waveform with 16 symbols in a fixed sensing time range has a smaller range RMSE than a waveform with 8 symbols in a fixed sensing time range for the same SNR. Similarly in FIG. 6B, a waveform with 8 symbols in a fixed sensing time range has a smaller Doppler RMSE than a waveform with 2 symbols in a fixed sensing time range for a given SNR and a waveform with 16 symbols in a fixed sensing time range has a smaller Doppler RMSE than a waveform with 8 symbols in a fixed sensing time range for the same SNR. Moreover, for a given number of symbols, the triangular chirp outperforms FMCW, especially at high SNRs.

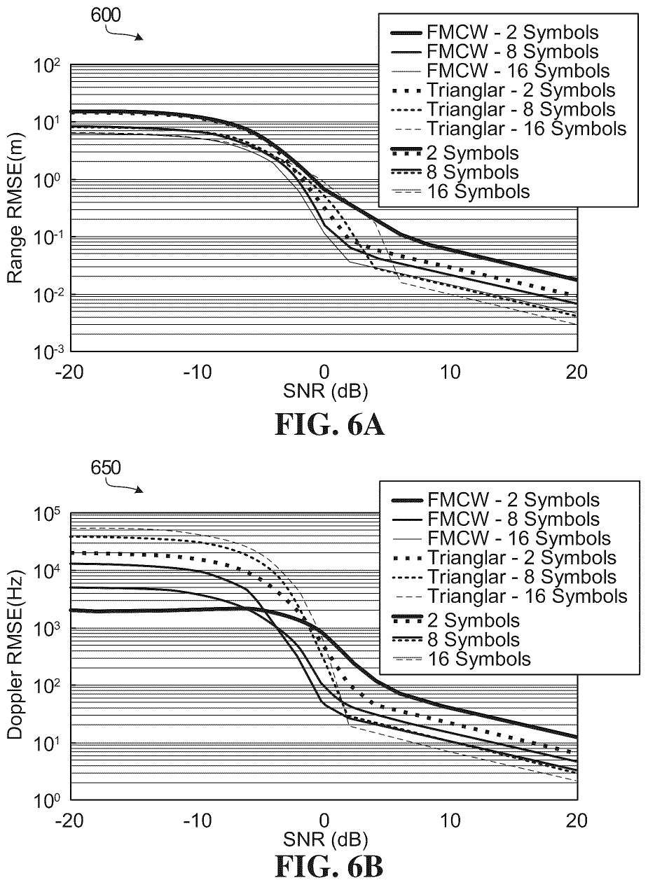

FIG. 7 is a table 700 illustrating a comparison of particular attributes of three different types of digital domain or analog domain waveforms, such as a ZC sequence, a FMCW waveform, and a symmetric triangular chirp waveform. The attributes being compared in the table 700 of FIG. 7 include analog capabilities of the UE, OOBE, sensing performance, and the receiver (Rx) complexity, or more generally sensing complexity.

When the contents of the table 700 in FIG. 7 are considered, it is considered that none of the types of waveforms provide good performance for all of the attributes or can be used for both digital and analog domain scenarios. For instance, the FMCW waveform has a low receiver complexity, but less desirable OOBE performance. On the other hand, the symmetric triangular chirp waveform has the best OOBE performance, but low to medium receiver complexity.

Table 700 shows that none of the existing waveforms have the best performance at the same time, i.e., having low OOBE with good sensing performance and low receiver complexity. The present disclosure provides a waveform configuration framework that enables a new waveform based on various criteria. The new waveform provides a trade-off among different ISAC requirements to provide a desirable performance at a particular point in time that has a certain set of operating conditions.

The basic chirp-based sensing waveform shall be generated according to the following expression:

$${x}_{α} ( t ) = exp ( j π α {t}^{2} + 2 π {f}_{0} t + {θ}_{0} ) . \qquad ( 5 )$$

In some embodiments, a chirp-based sensing waveform resource is configured by a higher layer parameter, such as a sensing waveform resource information element, that includes a sensing waveform bandwidth, B, and a sensing symbol time duration, Tₛ, that corresponds to the fixed sensing time.

In some embodiments, the chirp-based sensing waveform for a chirp-based sensing waveform resource in antenna port pᵢ, of the ith antenna port, and in the sensing symbol l′∈{0, 1, . . . , Nₛ−1}, where Nₛ the number of sensing symbols in a sensing waveform resource, may be generated according to the following expression:

$${x}^{( {p}_{i} )} ( t , {l}^{′} ) = {x}_{{{α}_{1 , l}}^{′}} ( t - {l}^{′} {T}_{s} ) Π ( \frac{t - {l}^{′} {T}_{s}}{{β}_{l ′} {T}_{s}} ) + ( 1 - {ϑ}^{( {p}_{i} )} ) {e}^{j 2 π ( {β}_{{l}^{′}} {α}_{1 , {l}^{′}} {T}_{s} ) t} {x}_{- {α}_{2 , {l}^{′}}} ( t - ( {l}^{′} + {β}_{l ′} ) {T}_{s} ) Π ( \frac{t - ( {l}^{′} + {β}_{l ′} ) {T}_{s}}{( 1 - {β}_{l ′} ) {T}_{s}} ) \qquad ( 6 )$$

where

$$Π ( \frac{t}{{T}_{s}} ) = \{ \begin{matrix}1 & 0 \leq t \leq {T}_{s} \\ 0 & otherwise\end{matrix} .$$

Nₛ is a waveform configuration parameter and regardless of the type of waveform that is used, the parameter may be adjusted depending on the desired KPIs and the receiver complexity.

The parameter ϑ^{(p}^{ᵢ}⁾∈{0, 1} is a higher layer signaling parameter (which may be identified, for example, as WaveformTypeIndicator) in the sensing waveform resource, which may be set to 1 for selection of a FMCW waveform, and set to 0 for selection of a symmetrical or non-symmetrical triangular chirp waveform. In the case when ϑ^{(p}^{ᵢ}⁾=1, By, may be set to 1, while in the case when ϑ^{(p}^{ᵢ}⁾=0, By may be determined based on

$${β}_{{l}^{′}} = \frac{B}{{α}_{1 , {l}^{′}} {T}_{S}} .$$

The chirp rate, α_{1,l′}, may be determined based on the following expression:

$${α}_{1 , {l}^{′}} = \frac{B}{{T}_{S}} ( 1 + \frac{{K}_{i n i t} + {n}_{ID} mod {n}_{S}^{max}}{{K}_{max}} ) , \qquad ( 7 )$$

where n_{ID} represents a sensing waveform sequence identity which is given by a higher layer signaling parameter, e.g., possibly having a name sequenceId, in the sensing waveform resource information element,

$${n}_{S}^{max} ,$$

Kᵢₙᵢₜ and Kₘₐₓ are constants. In the case of

$${ϑ}^{( {p}_{i} )} = 1 , {n}_{S}^{max}$$

shall be assumed to be equal to 1, Kₘₐₓ=1 and Kᵢₙᵢₜ=0.

In the case of ϑ^{(p}^{ᵢ}⁾=0.

$${n}_{S}^{max} ,$$

Kₘₐₓ, and Kᵢₙᵢₜ may be set according to look up tables that are previously provided and stored at the UE. In the case of ϑ^{(p}^{ᵢ}⁾=0, −_{2,l′} may be determined based on the following expression:

$${α}_{2 , {l}^{′}} = \frac{B {α}_{1 , {l}^{′}}}{{T}_{S} {α}_{1 , {l}^{′}} - B} \qquad ( 8 )$$

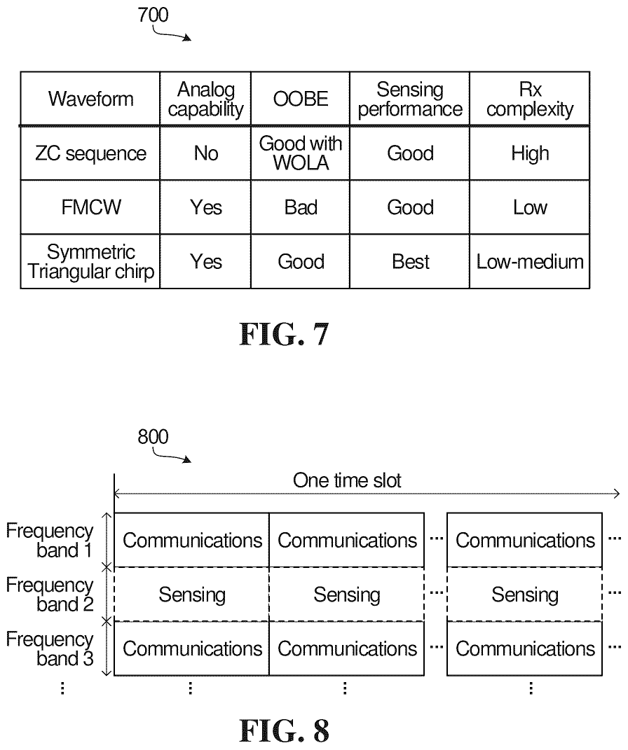

FIG. 8 illustrates a time and frequency resource 800 in which sensing is frequency-multiplexed with communications for uplink or downlink, or both. Sensing occurring in the frequency multiplexed time and frequency resource may be mono-static sensing, bi-static sensing or any combinations thereof. The time and frequency resource 800 is shown to be divided into multiple frequency bands, i.e., frequency band 1, frequency band 2, and frequency band 3 in the vertical axis and multiple symbols in one time slot. While only a single time slot and three frequency bands are shown, it is to be understood that a similar multiplexing may occur for additional time slots and frequency bands. Communications are shown to occur in frequency bands 1 and 3 and sensing occurs in frequency band 2 of the example of FIG. 8. FIG. 8 is merely an example and the multiplexing may occur for communications and sensing in any desirable arrangement.

Aspects of the present disclosure provide a waveform configuration framework that enables use of a new waveform that includes selection of a digital domain waveform or an analog domain waveform including at least a ZC sequence waveform, a FMCW waveform, a symmetric triangular chirp waveform, or a non-symmetric triangular chirp waveform based on one or more of the following parameters:
hardware constraints, e.g., supported ADC sampling rate by the UE;
radio frequency (RF) domain chirp generation capability or detection capability;
OOBE or any spectral emission or leakage requirement;
sensing performance, i.e., range RMSE or Doppler RMSE; or
sensing complexity, i.e., whether a low complexity receiver or a high complexity receiver is supported. Some embodiments enable a trade-off among the different parameters based on sensing key performance indicators (KPIs) and user-equipment (UE) capability and importance of the parameter, i.e., whether the parameter is an important constraint. Examples of KPIs may include resolution, accuracy, and latency.

In some embodiments the TRP selects a waveform from a group including a ZC sequence waveform, a FMCW waveform, a symmetric triangular chirp waveform, or a non-symmetric triangular chirp waveform depending on the various parameters mentioned above and whether constraints may be important. In particular, if OOBE and sensing performance are not constraints, but sensing complexity is a constraint, FMCW may be used, i.e., ϑ^{(p}^{ᵢ}⁾=1 with a corresponding chirp rate. On the other hand, if OOBE and sensing performance are constraints, but sensing complexity is not a constraint, then triangular chirp may be used, i.e., ϑ^{(p}^{ᵢ}⁾=0 with a corresponding chirp rate.

In some embodiments, a number of sensing symbols may impact the sensing performance.

Also, if the UE is static, Doppler estimation is not important. Therefore, if OOBE is not a constraint, then FMCW may be used. However, if the UE is mobile and Doppler estimation is important, then triangular chirp may be used.

The triangular chirp may be symmetric or non-symmetric. The non-symmetric triangular chirp can be expressed as:

$$x ( t ) = \{ \begin{matrix}{e}^{j ( - {πα}_{1} {t}^{2} + 2 π {f}_{0} t + {θ}_{0} )} & t ∈ [ 0 , {T}_{1} ] \\ {e}^{j ( + {πα}_{2} {t}^{2} + 2 π {f}_{0} t + {θ}_{0} )} & t ∈ [ {T}_{1} , {T}_{2} ]\end{matrix} \qquad ( 9 )$$

Where α₁ and α₂ denote the chirp rates, and T₁=B/α₁, is the duration of the first chirp, T₂=Tₛ, and T₂−T₁ is the duration of the second chirp.

In some embodiments, when the UE has RF domain chirp generation capability or detection capability, or both, and does not receive configuration information notifying the UE of the waveform, a default waveform that is to be used may be the symmetric triangular chirp.

After the TRP has determined an appropriate waveform, the TRP sends configuration information to the UE so that the UE can be configured to properly use the selected waveform.

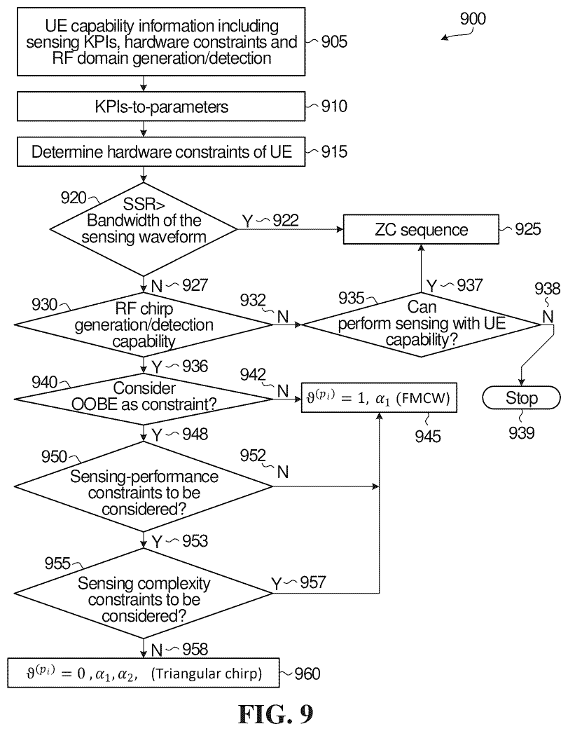

FIG. 9 includes a flow chart 900 of an example manner that may be performed in accordance with some embodiments of the waveform selection framework. Individual steps in the flow chart 900 may be performed by either a UE or a TRP and the steps will be indicated as such in the description below. This example illustrates an embodiment when the TRP is determining the sensing signal and sending configuration information to the UE to configure the UE to use the determined sensing signal.

At step 905, the UE reports UE capability information to the transmission/reception point (TRP). The UE capability may include information pertaining to hardware constraints of the UE. A non-limiting list of example hardware constraints includes a supported sampling rate (SSR) of an analog-to-digital convertor (ADC), transmitter (Tx) processing capability, and receiver (Rx) processing capability. The UE may also feedback UE RF domain chirp generation capability or RF domain chirp detection capability, or both, to the TRP.

At step 910, in some embodiments, the TRP may translate sensing KPIs to parameters, when this has not been previously performed. For example, a sensing resolution of ins translates to a bandwidth (BW) of 1 GHz.

At step 915, in some embodiments, the TRP determines hardware constraints for the UE based on the UE capability information received in step 905 and possibly other information that the TRP may be aware of if the UE has not provided explicit hardware constraints.

At step 920, the TRP compares SSR with the bandwidth of the sensing signal. When the SSR is greater than the bandwidth of the sensing signal (“Yes” 922), the UE is considered to be able to support transmission or reception, or both, of the sensing signal fully in the digital domain and a digital domain waveform may be used 925 as the waveform. A non-limiting example of a digital domain waveform is a ZC sequence. In some embodiments, ZC sequence is a NR ZC sequence with NR orthogonal frequency divisional multiplexing (OFDM) waveform with windowing/filtering.

When the SSR is less than the RSR (“No” 927), the TRP determines if the UE has RF chip generation capability or detection capability, or both, at step 930. The TRP may make such a determination based on information from the UE received in step 905 or determined in step 915, or both. When the UE is determined not to have RF chirp generation capability or detection capability, or both, (“No” 932), the TRP determines whether the UE can perform sensing with existing UE capability at step 935. When the UE can perform sensing with existing UE capability (“Yes” 937), a digital domain waveform, such as a ZC sequence waveform, may be used as the waveform at step 925. When the UE cannot perform sensing with existing UE capability (“No” 938), a selection is not made (“Stop” 939). In such a case the UE is not assigned a sensing task.

When the UE is determined to have RF chip generation capability or detection capability, or both, (“Yes” 936), the TRP determines at step 940 whether the UE has an OOBE constraint that should be considered.

When the TRP determines at step 940 that an OOBE constraint does not need to be considered (“No” 942), the TRP determines at step 945 that the sensing waveform that may be used as the waveform by the UE is an analog domain waveform, in particular a FMCW waveform, and notifies the UE that ϑ^{(p}^{ᵢ}⁾=1 and may provide the UE a value for α₁. The guard band for a FMCW waveform is larger than a guard band that is used for a triangular chirp waveform, such as used in step 960. This occurs because the triangular chirp has a better OOBE performance and thereby can use a smaller guard band.

When the TRP determines at step 940 that an OOBE constraint should be considered (“Yes” 948), the TRP determines at step 950 whether the UE has sensing performance constraints that should be considered. Examples of sensing-performance constraints may include resolution, accuracy, and latency.

When the TRP determines at step 950 that the UE does not have sensing performance constraints to be considered (“No” 952), the TRP determines that the sensing waveform that may be used by the UE is a FMCW waveform at step 945 and notifies the UE that ϑ^{(p}^{ᵢ}⁾=1 and may provide the UE a value for α₁.

When the TRP determines at step 950 that the UE has sensing performance constraints that should be considered (“Yes” 953), the TRP determines at step 955 whether the sensing complexity constraints should be considered. Examples of the sensing complexity constraints include generation, transmission, reception or detection of a sensing signal and its corresponding parameters. This may also include digital-to-analog convertor (DAC) sampling rate (i.e., for transmission), ADC sampling rate (i.e., for reception), receiver detection algorithms that may be for obtaining the sensing parameters from the received signal.

When the TRP determines at step 955 that the sensing complexity constraints of the UE need to be considered (“Yes” 957), the TRP determines that the sensing waveform that may be used by the UE is a FMCW waveform at step 945 and notifies the UE that ϑ^{(p}^{ᵢ}⁾=1 and may provide the UE a value for α₁.

When the TRP determines at step 955 that the sensing complexity of the UE does no need to be considered (“No” 958) the TRP determines at step 960 that the sensing waveform that may be an analog waveform, in particular a triangular chirp waveform, and notifies the UE that ϑ^{(p}^{ᵢ}⁾=0 and may provide the UE a value for α₁ and for α₂.

FIG. 9 describes an embodiment when the TRP is determining the sensing signal and sending configuration information to the UE to configure the UE to use the determined sensing signal. However, it is also within the scope of the present disclosure that the UE may determine the sensing signal and notify the TRP of the determined sensing signal. The UE may also feedback sensing KPI information. In some embodiments, the network may override the UE determined sensing signal by providing updated sensing parameters to the UE.

Subsequent to the UE reporting UE capabilities to the TRP and the TRP configuring waveform options, e.g., a NR ZC sequence, a FMCW waveform, a symmetric or non-symmetric triangular chirp waveform, through RRC signaling for the UE, additional configuration information may be provided to the UE, depending on whether the UE is the transmitter of the sensing signal or the receiver of sensing signal.

When the UE is the transmitter of the sensing signal, and the sensing KPIs and configuration (including required resolution, accuracy, bandwidth, and time) are determined by the network, the TRP may directly send the waveform configuration parameters to the UE, e.g., waveform type, number of symbols, etc., through dynamic L1 signaling, such as DCI.

When the UE is the transmitter of the sensing signal, but the sensing KPIs and configuration (including required resolution, accuracy, bandwidth, and time) are determined by the UE, the UE may select the waveform configuration parameters, e.g., waveform type, number of symbols, etc., and signal the network the selected parameters through dynamic signaling. In some embodiments, the network may override the UE decision by providing sensing updated parameters through DCI.

When the UE is the receiver of the sensing signal, the network may directly signal the UE the waveform configuration parameters by signaling, e.g., DCI or RRC.

When the UE is the transmitter and the receiver of the sensing signal, i.e., mono-static sensing, the network may directly signal the UE the waveform configuration parameters by signaling, e.g., DCI or RRC.

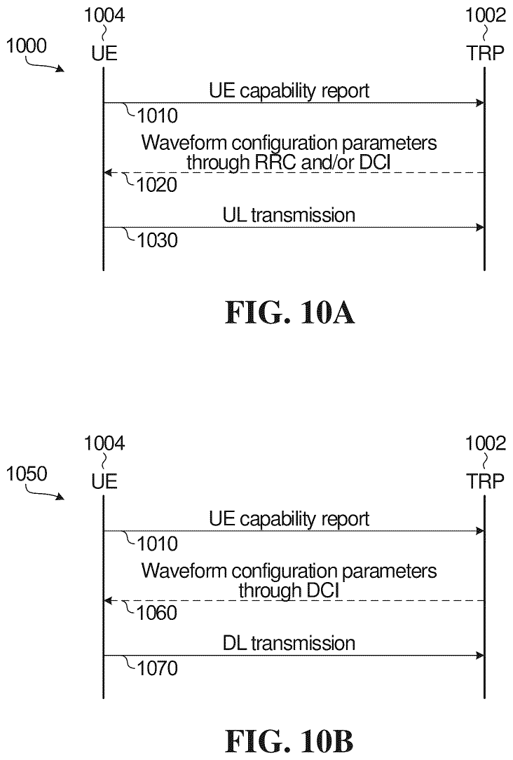

FIG. 10A and FIG. 10B show example signaling diagrams 1000, 1050 for communication between a TRP 1002 and a UE 1004 for uplink and downlink transmissions, respectively. In each of the UL and DL examples, the UE 1004 sends the TRP 1002 a UE capability report in signaling 1010 that includes information about the capability of the UE 1004.

In signaling 1020 of FIG. 10A, which is an optional signaling, the TRP 1002 may send waveform configuration information to the UE 1004 to provide information that can be used to configure the UE 1004. The waveform configuration parameters, i.e., number of symbols and the waveform type, may be performed semi-statically through RRC, or dynamically via DCI.

In FIG. 10A, the UE 1004 may then perform UL transmission 1030 that is multiplexed with sensing by the UE 1004.

In signaling 1060 of FIG. 10B, which is an optional signaling, the TRP 1002 may send waveform configuration information to the UE 1004 to provide information that can be used to configure the UE 1004. The waveform configuration parameters, may be performed by signaling e.g., via DCI or RRC.

In FIG. 10B, the UE 1004 may then perform DL transmission 1070 that is multiplexed with sensing by the UE 1004.

In LTE and 5G NR, an orthogonal frequency division multiplexing (OFDM) waveform is used to carry the communications data. Particularly, different data symbols are placed on different subcarriers, which are then multiplexed in the frequency domain to form an OFDM symbol. Each OFDM symbol is transformed into a time domain symbol using the inverse fast Fourier transform (IFFT). In order to combat a multipath fading effect, a cyclic prefix (CP) with a length n_{CP}, may be added to the beginning of each time-domain OFDM symbol. CP is basically a copy of the last n_{CP} samples of each OFDM symbol, where n_{CP} is an integer, that will be appended to the beginning of the symbol. A total time duration of a time-domain OFDM symbol including CP is represented by T, and T=T_{d}+T_{CP}, where T_{d} denotes a duration of each time-domain OFDM data symbol and T_{CP} denotes a time duration of the CP. An OFDM frame time duration, T_{F}, is equal to NT, where N denotes the number of OFDM symbols in an OFDM frame.

A total sensing time duration may be expressed as

$${T}_{s t} = {\sum }_{i = 1}^{{N}_{s}} {T}_{{s}_{i}} ,$$

where Nₛ represents the number of sensing symbols, where each sensing symbol has a per symbol sensing time duration, Tₛ_{ᵢ}, i∈{1, . . . , Nₛ}. Note that for the symmetric triangular chirp, Tₛ=Tₛ, ∀i∈{1, . . . , Nₛ}, and Tₛₜ=NₛTₛ.

In some embodiments, in order to align the timing of a periodic chirp-based sensing waveform with an OFDM frame, the OFDM frame time duration should be equal to the total sensing time duration, i.e., Tₛₜ=T_{F}, where T_{F} is equal to the duration of the OFDM frame. An analog sensing CP having a time duration T_{CPs}_{ᵢ}, which will be added to the beginning of each chirp-based sensing symbol so that Tₛ_{ᵢ}+T_{CPs}_{ᵢ}, constitutes a total sensing time duration per sensing symbol, and the total sensing duration per sensing signal may be expressed as:

$${T}_{{s}_{i}} + {T}_{{CPs}_{i}} = 1 / {n}_{i} T , {n}_{i} ∈ ℕ , \qquad ( 10 )$$

where nᵢ denotes a number of triangular chirps that are included in one OFDM time duration, and N is the set of Natural numbers.

In some embodiments, the analog chirp-based sensing waveform may be used as a demodulation reference signal (DMRS) that is used for channel estimation. To be able to use the analog chirp-based sensing waveform as a DMRS, the following condition must be met:

$${T}_{{s}_{i}} = 1 / {m}_{i} {T}_{d} , {m}_{i} ∈ ℕ \qquad ( 11 )$$

$${T}_{{CPs}_{i}} = {T}_{CP} .$$

where mᵢ denotes a number of triangular chirps that may be included in one OFDM data time duration. Note that equation (11) is more specific than equation (10), and in order to use the chirp-based sensing waveform as DMRS, the sensing CP time duration should be the same as the communications CP duration.

In some embodiments, in order to achieve a low OOBE, phase continuity between different sensing symbols is maintained. For a periodic chirp-based sensing waveform, the sensing CP may be formed by a cyclic shift of the chirp-based sensing waveform.

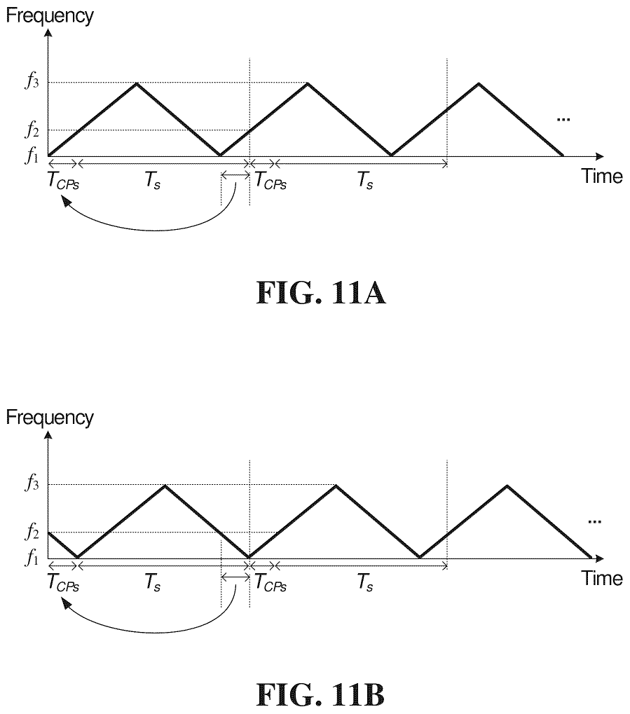

In some embodiments, a starting point for the chirp-based sensing waveform may be mapped to n_{ID} in equation (7) and configured for the UE. This may result in different sequences for different UEs, as shown in FIG. 11A and FIG. 11B, which show two examples of analog CP generation of a symmetric triangular chirp with different starting points. The triangular chirps shown in FIGS. 11A and 11B show time on the horizontal axis and frequency on the vertical axis. In FIGS. 11A and 11B, as total sensing duration per sensing signal is expressed as Tₛ+T_{CP}_{ₛ}, a first portion of a first sensing duration per sensing signal is T_{Cp}_{ₛ}, which is a replication of the last CP samples of the sensing symbol with duration Tₛ. Let f_{L}, and f_{H} represent the lowest and the highest frequencies/subcarriers of the chirp-based sensing waveform, respectively. The starting frequency may be either f_{L} or f_{H}. For example, in FIG. 11A, the first sensing duration per sensing signal starts at f1=f_{L}, and increases to f3=f_{H} then decreases back to f1 and then increases to f2. The starting frequency can also be as f_{L}+Rₛ_{₁}n_{CPs}_{₁} or f_{H}−Rₛ_{₁}n_{CPs}_{₁}, where n_{CPs}_{ᵢ} denotes the sensing CP length and Rₛ_{ᵢ} the sampling rate of the ith sensing symbol. We note that for a symmetric triangular chirp, n_{CPs}_{ᵢ}=n_{CPs} and Rₛₜ=Rₛ, ∀i∈{1, . . . , Nₛ}. In FIG. 11B, the first sensing duration per sensing signal starts at f2=f_{L}+Rₛ_{₁}N_{CPs}_{₁} decreases to f1=f_{L}, then increases to f3=f_{H} and then decreases back to f1. These are two examples of arrangements of symmetrical triangular chirps and it is to be understood that many other variations of arrangements that may be used, depending on the length of T_{CPs} and Tₛ and the frequencies involved. In some embodiments, different starting frequencies may be mapped to different UEs.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the figures or all of the portions schematically shown in the figures. Moreover, selected features of one example embodiment may be combined with selected features of other example embodiments.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

1. A method comprising:
receiving, by a user equipment (UE), configuration information for configuring a sensing waveform to be used by the UE, the configuration information comprising an indication indicating whether the sensing waveform is a digital domain waveform or an analog domain waveform; and
transmitting or receiving, by the UE, the sensing waveform for which the UE is configured to transmit or receive based on the configuration information.

2. The method of claim 1, wherein the indication indicates that the sensing waveform is the digital domain waveform, and the sensing waveform is a Zadoff-Chu sequence.

3. The method of claim 1, wherein the indication indicates that the sensing waveform is the analog domain waveform, and the sensing waveform is one of:
a frequency modulated continuous wave waveform (FMCW);
a non-symmetric triangular chirp waveform; or
a symmetric triangular chirp waveform.

4. The method of claim 1, further comprising:
transmitting, by the UE, capability information of the UE, the capability information pertaining to at least one of transmitting or receiving of communication signaling and sensing signaling between the UE and a network serving the UE.

5. The method of claim 4, wherein the capability information includes information pertaining to at least one of: hardware constraints of the UE; receiver complexity of the UE; an analog-to-digital convertor (ADC) sampling rate (SR) supported by the UE; transmitter processing capability of the UE; receiver processing capability of the UE; radio frequency (RF) domain chirp generation capability of the UE; RF domain chirp detection capability of the UE; or key performance indicators (KPIs) of the UE pertaining to sensing by the UE.

6. The method of claim 1, wherein the sensing waveform includes a cyclic prefix (CP), wherein the CP is used to align the sensing waveform with an orthogonal frequency division multiplexing (OFDM) frame.

7. The method of claim 6, wherein the aligning the sensing waveform with the OFDM frame comprises:
adding the CP so that a total sensing waveform time duration of the sensing waveform is equal to an OFDM frame time duration of the OFDM frame.

8. An apparatus comprising:
at least one processor; and
a memory storing instructions which, when executed by the at least one processor, cause the apparatus to perform:
receiving configuration information for configuring a sensing waveform to be used by the apparatus, the configuration information comprising an indication indicating whether the sensing waveform is a digital domain waveform or an analog domain waveform; and
transmitting or receiving the sensing waveform for which the apparatus is configured to transmit or receive based on the configuration information.

9. The apparatus of claim 8, wherein the indication indicates that the sensing waveform is the digital domain waveform, and the sensing waveform is a Zadoff-Chu sequence.

10. The apparatus of claim 8, wherein the indication indicates that the sensing waveform is the analog domain waveform, and the sensing waveform is one of:
a frequency modulated continuous wave waveform (FMCW);
a non-symmetric triangular chirp waveform; or
a symmetric triangular chirp waveform.

11. The apparatus of claim 8, wherein the instructions further cause the apparatus to perform:
transmitting capability information of the apparatus, the capability information pertaining to at least one of transmitting or receiving of communication signaling and sensing signaling between the apparatus and a network serving the apparatus.

12. The apparatus of claim 11, wherein the capability information includes information pertaining to at least one of: hardware constraints of the apparatus; receiver complexity of the apparatus; an analog-to-digital convertor (ADC) sampling rate (SR) supported by the apparatus;
transmitter processing capability of the apparatus; receiver processing capability of the apparatus; radio frequency (RF) domain chirp generation capability of the apparatus; RF domain chirp detection capability of the apparatus; or key performance indicators (KPIs) of the apparatus pertaining to sensing by the apparatus.

13. The apparatus of claim 8, wherein the sensing waveform includes a cyclic prefix (CP), wherein the CP is used to align the sensing waveform with an orthogonal frequency division multiplexing (OFDM) frame.

14. The apparatus of claim 13, wherein the aligning the sensing waveform with the OFDM frame comprises:
adding the CP so that a total sensing waveform time duration of the sensing waveform is equal to an OFDM frame time duration of the OFDM frame.

15. A method comprising:
transmitting, by a transmit receive point (TRP), configuration information for configuring a sensing waveform for a user equipment (UE), the configuration information comprising an indication indicating whether the sensing waveform is a digital domain waveform or an analog domain waveform; and
transmitting or receiving, by the TRP, the sensing waveform the UE is configured to receive or transmit based on the configuration information.

16. The method of claim 15, wherein the indication indicates that the sensing waveform is the digital domain waveform, and the sensing waveform is a Zadoff-Chu sequence.

17. The method of claim 15, wherein the indication indicates that the sensing waveform is the analog domain waveform, the sensing waveform is one of:
a frequency modulated continuous wave waveform (FMCW);
a non-symmetric triangular chirp waveform; or
a symmetric triangular chirp waveform.

18. The method of claim 15, further comprising:
receiving, by the TRP, capability information of the UE, the capability information pertaining to at least one of transmission or receiving of communication signaling and sensing signaling between the UE and a network serving the UE.

19. The method of claim 15, wherein the sensing waveform includes a cyclic prefix (CP), and wherein the CP is used to align the sensing waveform with an orthogonal frequency division multiplexing (OFDM) frame.

20. The method of claim 19, wherein the aligning the sensing waveform with the OFDM frame comprises:
adding the CP so that a total sensing waveform time duration of the sensing waveform is equal to an OFDM frame time duration of the OFDM frame.
